(19) United States
(12) Patent Application Publication
(10) Pub. No.: US 2005/0002299 A1
(43) Pub. Date: Jan. 6, 2005

(54) Clock generating device

(76) Inventors: Hideki Hirayama, Hashima-shi (JP); Takuya Shiraishi, Higashiosaka-shi (JP)

Correspondence Address: FISH & RICHARDSON PC, 225 FRANKLIN ST, BOSTON, MA, 02110, US

(21) Appl. No.: 10/781,330

(22) Filed: Feb. 18, 2004

(30) Foreign Application Priority Data
Feb. 20, 2003 (JP) 2003-042417

(51) Int. Cl. G11B 5/09

(52) U.S. Cl. 369/47.28; 369/47.27; 369/47.31; 369/53.31

(57) ABSTRACT

A clock generating device for accurately generating a reference clock signal synchronized with a wobble signal including address information recorded by phase modulating a groove wobble. The clock generating device includes a detection circuit, which monitors the wobble signal including the address information recorded through phase modulation. The detection circuit also detects the period in which the phase-modulated section of the wobble data signal is provided to a PLL circuit. When the period is detected, the detection circuit generates a hold signal to hold the output of the PLL circuit.

### BACKGROUND OF THE INVENTION

The present invention relates to a clock generating device, and more specifically, to a clock generating device for generating a clock signal for use in, for example, a recording control for disc media.

In recent years, disc-type recording media, such as optical discs and the like, have become popular. Among such disc media are media usable for data recording. For example, optical discs, such as digital versatile disc-recordable (DVD−R) and digital versatile-rewritable (DVD−RW) discs, may be used for data recording. Further, DVD+R and DVD+RW (hereinafter referred to as DVD+R/RW), which have disc recording formats differing from DVD−R and DVD−RW (hereinafter referred to as DVD−R/RW), have also become popular.

A DVD−R/RW has grooves, which are formed in flat surfaces (lands) of the disc, and tracks, which are formed by these grooves. The grooves are formed so as to meander (wobble) slightly. A wobble signal having a predetermined cycle is extracted from the wobble. The groove wobble is formed so as to correspond to the data recording section set in accordance with a specific data length based on the disc recording format.

The DVD−R/RW has a data format consisting of 26 frames (93 bytes) per sector, and a recording format in which eight cycles of the wobble signal are allocated to one frame. Furthermore, in addition to the wobble, sections for recording physical position information (address information) on the disc, referred to as land pre-pits (LPP), are provided at predetermined intervals on the tracks of a DVD−R/RW. An LPP is provided for every two frames, and an LPP signal obtained by reproducing the LPP is basically superimposed with the wobble signal at a rate of one to three pulses for every sixteen pulses. Then, address information is obtained by combining the LPP signals of one sector.

The DVD+R/RW is similar to the DVD−R/RW insofar as the data format includes 26 frames (93 bytes) per sector. However, the DVD+R/RW recording format differs from that of DVD−R/RW in that 93 cycles of the wobble signal are allocated to two frames. The DVD+R/RW does not have the LPPs and has an address in pre-groove (ADIP) that represents physical position information (address information) of a disc by phase modulating a wobble component to modulate the phase of the wobble signal. The ADIP is provided every two frames and is recorded by phase modulating the wobble signal of the first eight cycles of the 93 cycles of the wobble signal. Then, address information is obtained by combining the ADIPs included in one sector.

FIGS. 1(a) through 1(c) are waveform diagrams showing examples of phase-modulated wobble signal A in DVD+R/RW. For example, three types of phase modulation patterns respectively corresponding to SYNC (synchronous), bit value “0”, and bit value “1” are prepared. Each ADIP pattern in one sector is replaced by a corresponding value to generate data representing address information.

For example, FIG. 1(a) shows a SYNC (synchronous) pattern, FIG. 1(b) shows a pattern corresponding to bit value “0”, and FIG. 1(c) shows a pattern corresponding to bit value “1”. In the drawings, “PW” and “NW” respectively represent a positive phase and a negative phase of the wobble signal A. Further, signal B is a wobble data signal obtained by binary coding the wobble signal A.

When recording data on such disc media, the rotation of the disc medium is controlled, and a laser beam irradiates the disc medium, which is under controlled rotation. It is preferred that a reference clock signal synchronized with the rotation speed of the disc medium be used during the recording operation since this would enable accurate data recording control. For example, this would make a one-bit data recording section substantially uniform on the disc medium.

The wobble signal A is reproduced and binary-coded to generate the wobble signal B. A PLL circuit generates the reference clock signal as a pulse signal, synchronized with the wobble signal B. That is, a phase comparator of the PLL circuit compares the phase of the clock signal generated by a voltage-controlled oscillator and the phase of the wobble data signal B and feeds back voltage corresponding to the phase difference of the two signals to the voltage control oscillator to generate the reference clock signal, which is synchronized with the wobble signal A.

In this manner, in a phase-modulation type disc medium that uses the ADIP, which represents address information in a wobble, there is a location at which the cycle of the wobble data signal B differs from the original cycle of the wobble signal A (a location at which the pulse width increases) due to the inversion of the phase of wobble signal A (refer to FIGS. 1(a) through 1(c)). Therefore, when the reference clock signal is generated, the PLL circuit follows the location where the cycle becomes different. Thus, the reference clock signal cannot be accurately synchronized with the wobble signal A.

For this reason, in the prior art, the same PLL circuit cannot be used to generate two different reference clock signals, one for disc media using the LPP (e.g., DVD−R/RW) and the other for disc media using the ADIP (e.g., DVD+R/RW).

It is an object of the present invention to provide a clock generating device for accurately generating a reference clock signal synchronized with a wobble signal, which includes address information recorded by phase modulating the groove wobble.

### SUMMARY OF THE INVENTION

One aspect of the present invention is a clock generating device for generating a clock signal synchronizing with a wobble signal, which includes address information for a predetermined period. The clock generating device includes a PLL circuit for generating an oscillation signal in accordance with the difference between the phase of a wobble signal and the phase of a clock signal and for generating the clock signal by synchronizing the oscillation signal with the wobble signal. A detection circuit, connected to the PLL circuit, monitors the wobble signal, detects the predetermined period of the wobble signal that includes the address information, and holds the output of the PLL circuit in accordance with the detection.

A further aspect of the present invention is a clock generating device for generating a clock signal synchronizing with a wobble signal that includes address information during a predetermined period. The cycle of the wobble signal changes with at least two timings in accordance with the address information of the predetermined period. The clock generating device includes a PLL circuit for generating an oscillation signal in accordance with the difference between the phase of the wobble signal and the phase of the clock signal and for generating the clock signal by synchronizing the oscillation signal with the wobble signal. A monitor, connected to the PLL circuit, monitors the wobble signal. The monitor generates a first hold signal that holds the output of the PLL circuit during a first period between a first timing and a second timing, at which the cycle of the wobble signal changes, and a second hold signal that holds the output of the PLL circuit during a second period, which is longer than the first period of the first hold signal measured from the first timing. A signal selector, connected to the monitor, provides one of the first and second hold signals to the PLL circuit.

Other aspects and advantages of the invention will become apparent from the following description taken in conjunction with the accompanying drawings, which illustrate by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a waveform diagram showing the wobble signal of a SYNC pattern;

FIG. 1(b) is a waveform diagram showing the wobble signal of a pattern associated with the binary value of “0”;

FIG. 1(c) is a waveform diagram showing the wobble signal of a pattern associated with the bit value of “1”;

FIG. 2 is a schematic block diagram of a clock generating device, incorporated in a data recording controller, according to a preferred embodiment of the present invention; and

FIG. 3 is a waveform diagram illustrating the operation of a detection circuit of the clock generating device of FIG. 2 when an ADIP associated with the SYNC pattern is detected.

### DETAILED DESCRIPTION OF THE PREFERRED EMBODIMENTS

In the drawings, like numerals are used for like elements throughout.

A clock generating device 11 according to a preferred embodiment of the present invention will now be described with reference to the drawings. The clock generating device 11 is incorporated in a data recording controller adapted to a DVD+R/RW disc medium.

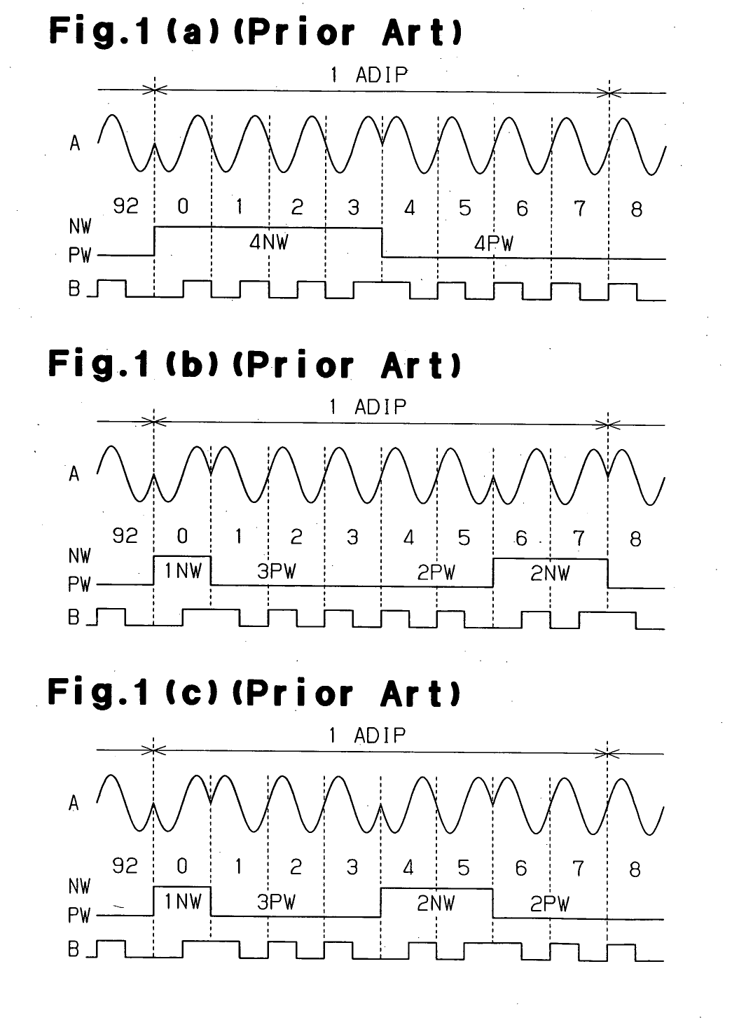

In a data recording controller, a recording subject for DVD+R/RW has a spiral pre-groove, which functions as a guide groove in the disc. The pre-groove includes a meandering (wobble) component having a predetermined cycle. A wobble signal having a frequency of 817.5 kHz is obtained from the wobble component. Furthermore, ADIPs representing physical position information (address information) on the disc are formed in the pre-groove by phase modulating the wobble component, and are written, for example, at the first eight cycles of wobble every 93 wobble cycles (refer to FIGS. 1(a) through 1(c)).

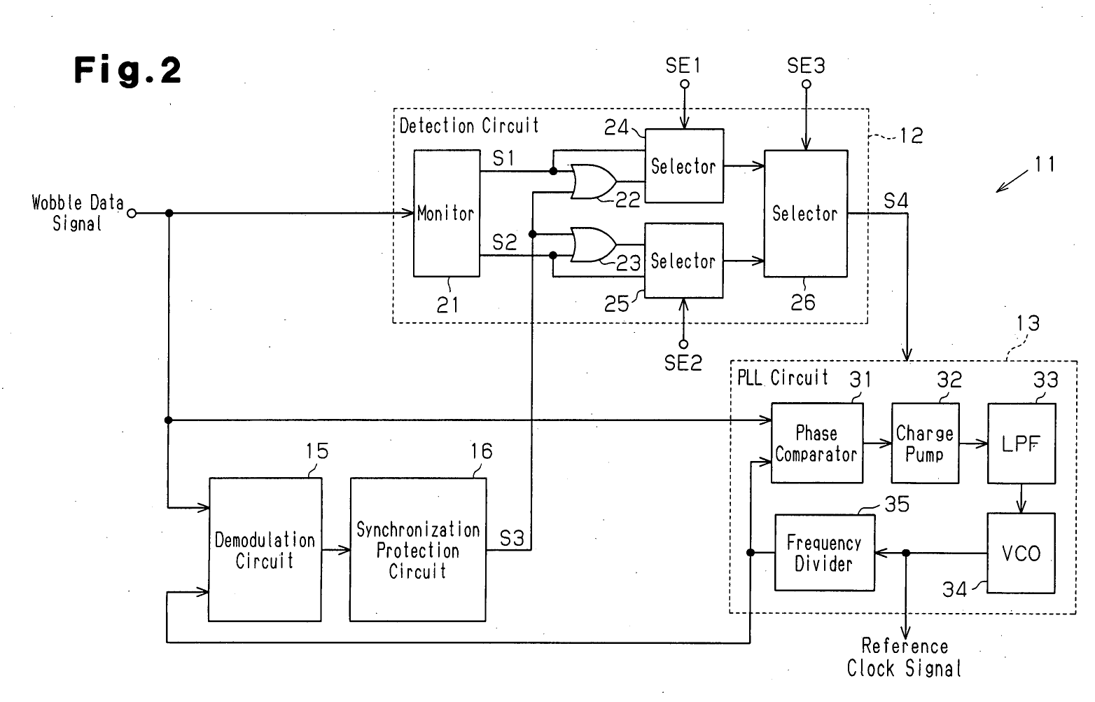

Referring to FIG. 2, the clock generating device 11 includes a detection circuit 12 and a PLL circuit 13. The detection circuit 12 monitors a binary coded wobble data signal, which is read from the disc, and detects the location at which the wobble data signal cycle differs from the original cycle of the wobble signal (location at which the pulse width increases) due to phase modulation. The clock generating device 11 generates a hold signal that holds the output of the PLL circuit 13 during a period corresponding to the detection result. The PLL circuit 13 compares the phase of its output signal (divisional signal) with the phase of the wobble data signal and adjusts the frequency of the clock signal based on voltage corresponding to the difference between the phases to generate a reference clock signal synchronized with the wobble signal.

The divisional clock signal of the PLL circuit 13 is provided to a demodulation circuit 15. The demodulation circuit 15 receives the divisional clock signal and the wobble data signal, detects the ADIP (phase modulated section of the wobble signal) recorded in the wobble signal, and demodulates the address information. A synchronization protection circuit 16 is connected to the demodulation circuit 15. The synchronization protection circuit 16 receives the wobble data signal through the demodulation circuit 15 and performs counting in accordance with the wobble data signal. The synchronization protection circuit 16 estimates the location (the period of the eight wobble cycles corresponding to one ADIP unit) at which each ADIP is recorded based on the count value to generate a synchronization protection signal in accordance with the estimated period. The synchronization protection signal goes high during the eight wobble cycles corresponding to one ADIP unit. Accordingly, the synchronization protection signal enables the boundary between every two frames of the wobble data signal to be recognized even when the ADIP period is not detected for one reason or another.

The detection circuit 12 includes a monitor 21, which serves as a hold signal generator, a first OR gate 22, a second OR gate 23, and three selectors 24, 25, and 26, which serve as signal selectors.

The monitor 21 monitors the wobble data signal, which is generated by binary coding the wobble signal, and generates first and second hold signals S1 and S2, which hold the output of the PLL circuit 13 at the location where the pulse width of the wobble data signal (wobble data signal B shown in FIGS. 1(a) through 1(c)) increases due to phase modulation.

The first hold signal S1 holds the output of the PLL circuit 13 at a location where the phase of the wobble data signal corresponding to each ADIP, which is recorded for every 93 wobble cycles, that is, a location at which the phase of the wobble data signal becomes negative (denoted as NW in FIG. 1). The second hold signal S2, which has a pulse width that is at least greater than that of the first hold signal S1, holds the output of the PLL circuit 13 for a certain period from the location of the first inversion of the phase of the wobble data signal corresponding to each ADIP, that is, the location at which the phase of the wobble data signal first becomes negative (MW in FIG. 1). The period during which the second hold signal S2 is output may, for example, be set in a register (not shown) to be slightly longer than the eight wobble cycles (one ADIP unit) that record address information.

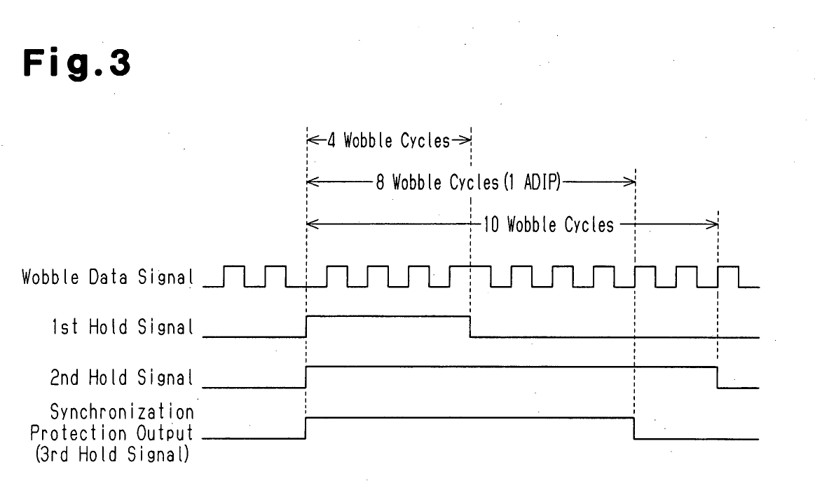

An example of a case in which an ADIP corresponding to a SYNC pattern (refer to FIG. 1(a)) is detected by the monitor 21 will now be discussed with reference to FIG. 3. In this case, among the eight cycles of the wobble data signal configuring one ADIP unit, the monitor 21 generates the first hold signal S1 at a high level during a period of four wobble cycles from the point at which the cycle of the wobble data signal first changes (first timing) to the point at which the cycle of the wobble data signal changes next (second timing). Furthermore, the monitor 21 generates the second hold signal S2 at a high level, for example, during ten wobble cycles, based on the register setting, from the point (timing) at which the cycle of the wobble data signal changes.

The first OR gate 22 performs a logical sum operation using the first hold signal S1, which is provided from the monitor 21 and a synchronization protection signal (third hold signal) S3, which is provided from the synchronization protection circuit 16, and provides a first OR signal to the first selector 24. The first selector 24 selects either the first hold signal S1 or the first OR signal in response to a first selector signal SE1 and provides the selected signal to the third selector 26.

The second OR gate 23 performs a logical sum operation using the second hold signal S2, which is provided from the monitor 21, and the synchronization protection signal (third hold signal) S3, which is provided from the synchronization protection circuit 16, and provides a second OR signal to the second selector 25. The second selector 25 selects either the second hold signal S2 or the second OR signal in response to a second selector signal SE2 and provides the selected signal to the third selector 26.

The third selector 26 selects either the signal selected by the first selector 24 or the signal selected by the second selector 25 in response to a third selector signal SE3, and supplies the selected signal to the PLL circuit 13 as a hold signal S4.

The selector signals SE1, SE2, and SE3 are respectively provided to the selectors 24, 25, and 26 from a control circuit (not shown).

In this way, the detection circuit 12 provides the PLL circuit 13 with, as a hold signal S4, one of the first and second hold signals S1 and S2, which are received from the monitor 21, and the synchronization protection signal S3 (third hold signal).

The PLL circuit 13 includes a phase comparator 31, a charge pump 32, a low-pass filter (hereinafter referred to as LPF) 33, voltage-controlled oscillator (hereinafter referred to as VCO) 34, and a frequency divider 35.

The phase comparator 31 receives a divisional signal from the divider 35 and the wobble data signal. Then, the phase comparator 31 compares the phases of the two signals and provides the charge pump 32 with a phase difference signal having a pulse width corresponding to the phase difference. The charge pump 32 supplies the LPF 33 with current corresponding to the phase difference signal from the phase comparator 31. The LPF 33 supplies the VCO 34 with voltage corresponding to the amount of the output current of the charge pump 32. The VCO 34 oscillates in accordance with the output voltage of the LPF 33 and generates an oscillation signal, which serves as a reference clock signal.

The divider 35 receives the oscillation signal from the VCO 34, divides the oscillation signal by a predetermined dividing ratio, and generates a divisional signal having a frequency corresponding to the dividing ratio. The divisional signal is fed back to the phase comparator 31.

In this manner, the PLL circuit 13 changes the output current value of the charge pump 32 and the output voltage value of the LPF 33 based on the phase difference signal from the phase comparator 31. Further, the PLL circuit 13 changes the oscillation frequency of the VCO 34 in accordance with these changes. The PLL circuit 13 synchronizes the reference clock signal (specifically, the divisional signal of the oscillation clock signal of the VCO 34) to the wobble signal by repeating such feedback operation.

The hold signal S4 from the detection circuit 12 is provided to the phase comparator 31 of the PLL circuit 13. The phase comparator 31 stops the phase comparison of the wobble signal and the oscillation clock signal of the VCO 34 (i.e., the divisional signal of the oscillation clock signal) in response to the hold signal S4. By stopping the comparison, the current value of the charge pump 32 and the voltage value of the LPF 33 remain substantially constant, and the oscillation frequency of the VCO 34 remains substantially constant. That is, when the comparison is stopped, the frequency of the reference clock signal output from the PLL circuit 13 is held substantially constant. Accordingly, when generating the reference clock signal, the PLL circuit 13 accurately generates the reference clock signal in precise synchronism with the wobble data signal without following changes in the cycle of the wobble data signal.

Although the above description has been given in terms of generating a reference clock signal synchronized to a DVD+R/RW wobble data signal, in the clock generating device 11 of the preferred embodiment, a reference clock signal may also be generated synchronized to the wobble signal of a DVD−R/RW disc medium by changing the dividing ratio of the divider 35.

For example, in DVD+R/RW, the dividing ratio of the divider 35 is set at 1/32 to generate a reference clock signal having a frequency of 26.16 MHz by allocating 32 cycles of the reference clock signal to two cycles of a wobble data signal having a frequency of 817.5 kHz. In a DVD−R/RW, the dividing ratio of the divider 35 is set at 1/186 to generate a reference clock signal having a frequency of 26.16 MHz by allocating 186 cycles of the reference clock signal to two cycles of a wobble data signal having a frequency of 140 kHz.

The clock generating device 11 of the preferred embodiment has the advantages described below.

(1) The detection circuit 12 monitors the wobble signal (that is, the wobble data signal) and generates a hold signal S4 for holding the output of the PLL circuit 13 at a location at which the cycle of the wobble signal changes. When the output of the PLL circuit 13 is held by the hold signal S and the reference clock signal is generated, the PLL circuit 13 is prevented from following changes in the cycle of the wobble signal. Accordingly, the clock generating device 11 generates a clock signal accurately synchronized to the wobble signal.

(2) The detection circuit 12 outputs one of the first and second hold signals S1 and S2, which have two different hold periods and which are received from the monitor 21, as the hold signal S4. The selective usage of the two types of hold signals enables the hold period of the PLL circuit 13 to be changed. That is, when the first hold signal S1 is used as the hold signal S4, the hold period of the PLL circuit 13 is minimized, and the reference clock signal is synchronized with the wobble signal at high speed. Furthermore, when the second hold signal S2 is used as the hold signal S4, the PLL circuit 13 is specifically prevented from following changes in the cycle of the wobble signal.

(3) The detection circuit 12 outputs the synchronization protection signal S3 from the synchronization protection circuit 16 as a hold signal S4 to hold the PLL circuit 13 during the period in which the wobble signal is provided at locations corresponding to where the ADIPs are recorded. By using the synchronization protection signal S3, even if the monitor 21 cannot detect a change in the cycle of the wobble signal, the PLL circuit 13 is prevented from following a cycle change.

(4) The same PLL circuit 13 is used to generate reference clock signals corresponding to different types of disc media, such as DVD−R/RW and DVD+R/RW, having different recording formats by changing the dividing ratio of the divider 35. This avoids an increase in the circuit scale of the clock generating device 11.

It should be apparent to those skilled in the art that the present invention may be embodied in many other specific forms without departing from the spirit or scope of the invention, Particularly, it should be understood that the invention may be embodiment in the following forms.

The first hold signal S1 is not limited to the configuration of the preferred embodiment. That is, the first hold signal S1 is only required to hold the PLL circuit 13 at least when the cycle of the wobble data signal differs from the original cycle of the wobble signal in locations where an ADIP is recorded (period of eight wobble cycles).

The second hold signal S2 is not limited to the configuration of the preferred embodiment. That is, the setting of the register may be adjusted to change the period during which the second hold signal S2 is active to be longer than or shorter than the eight wobble cycles corresponding to one ADIP unit.

The method for holding the PLL circuit 13 is not limited to the method of the preferred embodiment. For example, the output of the PLL circuit 13 may be held by providing the hold signal S4 from the detection circuit 12 to the charge pump 32. In this case, the charge pump 32 ignores the phase difference signal of the phase comparator 31 when the hold signal S4 is being provided and outputs a constant current value. The output of the PLL circuit 13 may also be held by providing the hold signal S4 to both the phase comparator 31 and the charge pump 32.

The charge pump 32 may be of a current output type instead of a voltage output type.

The present invention may be applied to disc recording media other than DVD+R/RW.

Therefore, the present examples and embodiments are to be considered as illustrative and not restrictive and the invention is not to be limited to the details given herein, but may be modified within the scope and equivalence of the appended claims.

1. A clock generating device for generating a clock signal synchronizing with a wobble signal, which includes address information for a predetermined period, the clock generating device comprising:
a PLL circuit for generating an oscillation signal in accordance with the difference between the phase of a wobble signal and the phase of a clock signal and for generating the clock signal by synchronizing the oscillation signal with the wobble signal; and
a detection circuit, connected to the PLL circuit, for monitoring the wobble signal, detecting the predetermined period of the wobble signal that includes the address information, and holding the output of the PLL circuit in accordance with the detection.

2. The clock generating device of claim 1, wherein the detection circuit includes:
a hold signal generator for generating a first hold signal that holds the output of the PLL circuit during a first period in accordance with the detection, and a second hold signal that holds the output of the PLL circuit during a second period in accordance with the detection, which differs from the first period; and
a signal selector, connected to the hold signal generator, for providing the PLL circuit with either one of the first and second hold signals.

3. The clock generating device of claim 2, wherein the first period is shorter than the predetermined period, and the second period is longer than the predetermined period.

4. The clock generating device of claim 2, wherein the cycle of the wobble signal changes with at least two timings in accordance with the address information of the predetermined period, and the hold signal generator generates a first hold signal for holding the output of the PLL circuit during a period between a first timing and a second timing, at which the cycle of the wobble signal changes.

5. The clock generating device of claim 2, wherein the cycle of the wobble signal changes during the predetermined period, and the hold signal generator generates the second hold signal for holding the output of the PLL circuit during the second period, which is longer than the first period of the first hold signal, from a timing at which the cycle of the wobble signal changes.

6. The clock generating device of claim 2, further comprising:
a synchronization protection circuit, connected to the detection circuit, for performing counting in accordance with the wobble signal, estimating the predetermined period during which the address information is included in the wobble signal, and generating a synchronization protection signal in accordance with the estimated period, the signal selector of the detection circuit providing the PLL circuit with one of the first hold signal, the second hold signal, and the synchronization protection signal.

7. The clock generating device of claim 6, wherein the PLL circuit includes:
a phase comparator circuit for generating a phase difference signal in accordance with the difference between the phase of the wobble signal and the phase of the oscillation signal; and
a charge pump, connected to the phase comparator, for generating an output signal in accordance with the phase difference signal, wherein at least one of the phase comparator and the charge pump stops functioning in response to one of the first hold signal, the second hold signal, and the synchronization protection signal.

8. The clock generating device of claim 7, further comprising:
a frequency divider, connected to the phase comparator, for generating a divisional signal by dividing the oscillation signal by a predetermined dividing ratio, and providing the divisional signal to the phase comparator, the dividing ratio being changed in accordance with the cycle of the wobble signal.

9. The clock generating device of claim 2, wherein the PLL circuit includes:
a phase comparator circuit for generating a phase difference signal in accordance with the difference between the phase of the wobble signal and the phase of the oscillation signal; and
a charge pump, connected to the phase comparator, for generating an output signal in accordance with the phase difference signal, wherein at least one of the phase comparator and the charge pump stops functioning in response to one of the first and second hold signals.

10. The clock generating device of claim 9, further comprising:
a frequency divider, connected to the phase comparator, for generating a divisional signal by dividing the oscillation signal by a predetermined dividing ratio, and providing the divisional signal to the phase comparator, wherein the dividing ratio is changed in accordance with the cycle of the wobble signal.

11. A clock generating device for generating a clock signal synchronizing with a wobble signal that includes address information during a predetermined period, wherein the cycle of the wobble signal changes with at least two timings in accordance with the address information of the predetermined period, the clock generating device comprising:
a PLL circuit for generating an oscillation signal in accordance with the difference between the phase of the wobble signal and the phase of the clock signal and for generating the clock signal by synchronizing the oscillation signal with the wobble signal;
a monitor, connected to the PLL circuit, for monitoring the wobble signal, wherein the monitor generates a first hold signal that holds the output of the PLL circuit during a first period between a first timing and a second timing, at which the cycle of the wobble signal changes, and a second hold signal that holds the output of the PLL circuit during a second period, which is longer than the first period of the first hold signal measured from the first timing; and
a signal selector, connected to the monitor, for providing one of the first and second hold signals to the PLL circuit.

12. The clock generating device of claim 11, further comprising:
a synchronization protection circuit, connected to the detection circuit, for performing counting in accordance with the wobble signal, estimating the predetermined period during which the address information is included in the wobble signal, and generating a synchronization protection signal in accordance with the estimated period, the signal selector of the detection circuit providing the PLL circuit with one of the first hold signal, the second hold signal, and the synchronization protection signal.

13. The clock generating device of claim 12, wherein the PLL circuit includes:
a phase comparator circuit for generating a phase difference signal in accordance with the difference between the phase of the wobble signal and the phase of the oscillation signal; and
a charge pump, connected to the phase comparator, for generating an output signal in accordance with the phase difference signal, wherein at least one of the phase comparator and the charge pump stops functioning in response to one of the first hold signal, the second hold signal, and the synchronization protection signal.
